(19) United States
(12) Patent Application Publication
(10) Pub. No.: US 2026/0314543 A1
(43) Pub. Date: Oct. 15, 2026

(54) MULCHING PAPER FOR GREENHOUSE AND PREPARATION METHOD THEREFOR

(71) Applicant: QILU UNIVERSITY OF TECHNOLOGY (SHANDONG ACADEMY OF SCIENCES), Jinan (CN)

(72) Inventors: Xingxiang JI, Jinan (CN); Gaojin LV, Jinan (CN); Hao MA, Jinan (CN); Zhongjian TIAN, Jinan (CN); Dongxing WANG, Jinan (CN); Xuejun SHAO, Jinan (CN); Wenjia HAN, Jinan (CN)

(21) Appl. No.: 19/484,426

(22) PCT Filed: Sep. 28, 2023
(86) PCT No.: PCT/CN2023/122630

§ 371 Date: Nov. 14, 2025

(30) Foreign Application Priority Data
Jun. 2, 2023 (CN) 202310661608.8

(51) Int. Cl. A01G 13/33; D21H 17/29; D21H 17/45; D21H 19/20; D21H 19/82; D21H 19/84; D21H 27/00

(52) U.S. Cl. CPC A01G 13/33; D21H 17/29; D21H 17/45; D21H 19/20; D21H 19/824; D21H 19/84; D21H 27/00

(57) ABSTRACT

A mulching paper for a greenhouse, and a preparation method for the mulching paper includes the following steps: subjecting wheat straw biomechanical pulp to beating treatment with a beating degree of 35° SR-40° SR to obtain a pulp slurry; thoroughly mixing the pulp slurry with a papermaking additive, and then performing papermaking to obtain a mulching base paper; uniformly coating one side or both sides of the mulching base paper with gelatinized cationic starch (CAS) or gelatinized soybean oil-modified starch, and drying; and then uniformly coating the one side or both sides with a polyurethane or acrylic resin coating, and drying to obtain the mulching paper. The mulching paper uses the biomechanical pulp as the main raw material. Through methods of addition into the pulp and surface coating, high physical and mechanical properties and high hydrophobicity and moisture resistance of the mulching paper are achieved.

### CROSS REFERENCE TO RELATED APPLICATION

The present invention claims priority benefits to Chinese Patent Application No. 202310661608.8 filed with China National Intellectual Property Administration on Jun. 2, 2023, and entitled “MULCHING PAPER FOR GREENHOUSE AND PREPARATION METHOD THEREFOR”, the entire contents of which are incorporated herein by reference.

### TECHNICAL FIELD

The present invention belongs to the technical field of mulching papers, and specifically relates to a mulching paper for a greenhouse and a preparation method therefor.

### BACKGROUND

The statements herein only provide the background related to the present invention and do not necessarily constitute the prior art.

As a major agricultural country, China has become the world's largest producer and user of agricultural films. At present, most mulching films are primarily made from petroleum-based plastics such as polyvinyl chloride (PVC) and polyethylene (PE), which are difficult to fully degrade when left in the soil, thereby damaging the ecosystem. Black mulching film, a commonly used plastic mulching film laid in crop greenhouses, can achieve effects such as heat preservation, moisture retention, and weed control. It is often used to improve the growth environment of crops, enhance fertilizer utilization efficiency, and prevent weeds from affecting crop quality.

Due to environmental pollution caused by plastic mulching films, degradable mulching films have gradually become a research focus, among which paper-based mulching films have certain advantages. Paper-based mulching films are prepared by papermaking technology, using plant fibers as raw materials through mixing different pulps or pulps at different ratios. They have certain dry strength and light-shielding properties, but their light-shielding performance is inferior to that of black mulching films, resulting in weaker weed growth suppression.

More importantly, traditional black plastic-based mulching films have excellent moisture retention, effectively preventing soil moisture evaporation. However, paper-based mulching films have relatively poor water vapor barrier properties, making it difficult to meet the moisture retention requirements of black plastic mulching films. In addition, current paper-based mulching films still lack the high dry strength and wet strength required for greenhouse use. Moreover, their high preparation cost has posed a significant obstacle to popularization and application.

Therefore, although current paper-based mulching films have good biodegradability, they still struggle to replace black plastic mulching films.

### SUMMARY

To address the deficiencies in the prior art, an objective of the present invention is to provide a mulching paper for a greenhouse and a preparation method therefor. The mulching paper uses the biomechanical pulp as the main raw material. Through methods of addition into the pulp and surface coating, high physical and mechanical properties and high hydrophobicity and moisture resistance of the mulching paper are achieved. The mulching paper can replace a black plastic mulching film to solve problems such as environmental pollution caused by plastic mulching films.

In order to achieve the aforementioned objective, the present invention is achieved through the following technical solutions:

In a first aspect, the present invention provides a method for preparing a mulching paper for a greenhouse, including the following steps: disintegrating a biomechanical pulp of wheat straw, then subjecting the disintegrated biomechanical pulp to beating treatment with a beating degree of 35° SR-40° SR to obtain a pulp slurry;
thoroughly mixing the pulp slurry with a papermaking additive, and then performing papermaking to obtain a mulching base paper;
uniformly coating one side or both sides of the mulching base paper with gelatinized cationic starch (CAS) or gelatinized soybean oil-modified starch, and carrying out a drying treatment on the mulching base paper; wherein a mass percentage of the starch in the gelatinized CAS is 3%-10%, and a mass percentage of the starch in the gelatinized soybean oil-modified starch is 2.5%-10%;
and then, uniformly coating the one side or the both sides with a polyurethane or acrylic resin coating, and carrying out the drying treatment to obtain the mulching paper.

In some implementation modes, the papermaking additive includes 0.5%-3% by a bone dry pulp mass percentage of cationic polyacrylamide (CPAM) or CAS or chitosan, 1.5%-3% by the bone dry pulp mass percentage of polyamide polyamine epichlorohydrin (PAE), 0.5%-2% by the bone dry pulp mass percentage of alkyl ketene dimer (AKD) or aluminum sulfate, and 0.1%-0.3% by the bone dry pulp mass percentage of cationic/anionic polyacrylamide or cationic/anionic starch.

The biomechanical pulp is first pretreated with a biological enzyme and then prepared by mechanical refining. The biological enzyme is a composite enzyme composed of pectinase, lipase and xylanase in a certain ratio. The adoption of biomechanical pulp transforms the traditional high-temperature and high-alkali pulping into low-temperature and low-alkali or alkali-free biological green pulping technology. By combining modern biotechnology with mechanical pulping of agricultural straws and replacing traditional chemicals with biological enzyme preparations, it cannot only solve the problem of papermaking raw material shortage caused by a sharp decline in waste paper imports, but also achieve zero discharge of wastewater.

By adding the PAE (wet strength agent) into the pulp, the paper exhibits significant wet strength enhancement and surface water resistance, and the specific dosage was discussed. When an addition amount reaches 2.5%, the optimal effect is achieved (see Example 4 for details).

To achieve a water vapor transmission rate below 800 g/m²·24 h, the inventors have explored the internal sizing process and surface coating process. The first layer coated during the surface coating process is a gelatinized CAS coating or a gelatinized soybean oil-modified starch coating. By using only the gelatinized CAS coating or the gelatinized soybean oil-modified starch coating, the water vapor transmission rate can be reduced from 2895 g/m²·24 h of the base paper to below 2100 g/m²·24 h. The second layer coated is a hydrophobic and moisture-resistant coating, which is a coating of polyurethane or acrylic resin. Under the premise of minimizing the coating amount, both the polyurethane coating and the acrylic resin coating enable the water vapor transmission rate of the mulching paper to reach below 800 g/m²·24 h.

The hydrophobic and moisture-resistant coating can also enhance the mechanical and hydrophobic properties of the paper-based mulching film.

For both natural-color mulching papers coated with acrylic resin and polyurethane, the degradable portions account for more than 95% of the total mass percentage of the mulching film, enabling almost complete biodegradation after use. Degradation experiments show that the two types of mulching papers still maintain good original appearance after 80 days in soil.

To reduce visible light transmittance and achieve a visible light transmittance effect of less than 5%, wheat straw biomechanical pulp is used as the raw material. This material has the advantages of environmental protection, a low cost, and light blocking. The obtained mulching base paper has a low visible light transmittance of 3.6%, and the subsequent gelatinized CAS or modified starch coating further reduces the light transmittance, keeping the visible light transmittance of the mulching paper consistently below 5%.

Experiments show that the gelatinized CAS layer or modified starch layer coated in the present invention cannot only improve the water vapor barrier property and visible light barrier property of the paper-based mulching film, but also enhance the mechanical strength and smoothness of the paper-based mulching film, and reduce its water absorption rate. In addition, the gelatinized CAS layer or modified starch layer also has a good pore-filling effect, which can reduce the coating amount of hydrophobic and moisture-resistant coating materials such as polyurethane and acrylic resin, effectively save the preparation cost of the mulching paper, and facilitate the popularization and application of the mulching paper.

By adding 0.5%-3% by the bone dry pulp mass percentage of a dry strength agent (i.e., CPAM or CAS or chitosan) to the biomechanical pulp, the dry strength of the base paper can be increased by up to about 30%.

By adding 1.5%-3% by the bone dry pulp mass percentage of a wet strength agent (i.e., PAE) to the biomechanical pulp, the wet strength of the base paper can be increased by up to about 369%.

By adding 0.5%-2% by the bone dry pulp mass percentage of a sizing agent (i.e., AKD or aluminum sulfate) to the biomechanical pulp, in combination with the dry and wet strength agents, the dry strength of the base paper can be increased by up to about 46%, and the wet strength thereof can be increased by up to about 400%.

And, by adding 0.1%-0.3% by the bone dry pulp mass percentage of a retention aid (i.e., cationic/anionic polyacrylamide or cationic/anionic starch) to the biomechanical pulp, the retention rate of the pulp during forming on the wire can be effectively improved, which has a good retention effect on fine fibers and significantly saves the pulp. Moreover, due to the good retention rate of fine fibers, the light transmittance of the prepared paper-based mulching film can be effectively reduced to better suppress weed growth. When the addition amount of the retention aid is excessive, deposits will appear.

In some implementation modes, the method further includes a step of adding 0-40% by mass percentage of waste corrugated paper pulp or 0-40% by mass percentage of wheat straw pulp to the biomechanical pulp of wheat straw.

Adding the waste corrugated paper pulp or the wheat straw pulp to the wheat straw biomechanical pulp can reduce costs. Experiments show that when 0-40% by mass percentage of the waste corrugated paper pulp or the wheat straw pulp is added to the wheat straw biomechanical pulp, the dry and wet strengths of the prepared paper-based mulching film do not significantly decrease. Furthermore, the dark-colored waste corrugated paper pulp is more conducive to reducing the visible light transmittance of the mulching paper.

In some implementation modes, the papermaking additive includes 0.5%-2% by the bone dry pulp mass percentage of the CPAM or the CAS or the chitosan, 2%-3% by the bone dry pulp mass percentage of the PAE, 0.5%-1% by the bone dry pulp mass percentage of the AKD or the aluminum sulfate, and 0.1%-0.2% by the bone dry pulp mass percentage of the cationic/anionic polyacrylamide or the cationic/anionic starch.

Preferably, the papermaking additive includes 1%-2% by the bone dry pulp mass percentage of the CPAM, 2%-3% by the bone dry pulp mass percentage of the PAE, and 0.5%-1% by the bone dry pulp mass percentage of the AKD.

In some implementation modes, a preparation of the gelatinized CAS includes: adjusting a CAS aqueous solution to an alkaline condition, heating the CAS aqueous solution to 40° C.-50° C., and stirring for 20-40 min to obtain the gelatinized CAS.

Preferably, a mass percentage of the starch in the CAS aqueous solution is 3%-10%, and more preferably is 7%.

Preferably, in the CAS aqueous solution, a mass percentage of a sodium hydroxide is 8%-15%.

In some implementation modes, a preparation of the gelatinized soybean oil-modified starch includes: adding soybean oil and sodium carbonate to a dimethyl sulfoxide solution of the starch to obtain a mixed solution, and heating the mixed solution to 110° C.-150° C. for 1-3 h, and then carrying out a hydrophobic modification on the starch to the modified starch.

Wherein, substituting hydroxyl groups with soybean oil to modify the starch via esterification can effectively improve the hydrophobicity of the starch. Sodium carbonate is used as a catalyst to promote the modification reaction.

Preferably, in the mixed solution, a mass percentage of the starch is 2.5%-10%, a mass percentage of the soybean oil is 8%-12%, and a mass percentage of the sodium carbonate is 13%-17%.

Preferably, the modified starch undergoes the same gelatinization process as the CAS.

In some implementation modes, a method for coating the gelatinized CAS or the gelatinized soybean oil-modified starch includes: using a 10-μm linear coating rod to coat a surface of the mulching base paper, and drying.

Preferably, a single-side coating amount of the gelatinized CAS or the gelatinized soybean oil-modified starch is 1.5-2 g/m², and a double-side coating amount of the gelatinized CAS or the gelatinized soybean oil-modified starch is 3-4 g/m².

In some implementation modes, a method for coating the hydrophobic and moisture-resistant coating material is: using a 4-μm linear coating rod to coat a surface of a gelatinized CAS or gelatinized modified starch coating, and drying.

Preferably, a single-side coating amount of polyurethane is 1.5-2 g/m², and a double-side coating amount of polyurethane is 3-4 g/m².

Preferably, a single-side coating amount of acrylic resin is 2.5-3 g/m², and a double-side coating amount of acrylic resin is 5-6 g/m².

Compared with the impregnation method and spraying method, the coating method can accurately control the coating material amount, and the formed coating has good uniformity. The 4-μm linear coating rod can minimize the coating amount.

In some implementation modes, a basis weight of the mulching base paper is 60-70 g/m².

A drying temperature for both polyurethane and acrylic resin coatings is 105° C.-110° C.

In a second aspect, the present invention provides a mulching paper for a greenhouse, prepared by the described preparation method.

The beneficial effects achieved by one or more embodiments of the present invention are as follows:

1) The water resistance Cobb₁₂₀ of the mulching paper is ≤20 m², showing a certain hydrophobic property, which helps to extend the service life of the mulching paper in humid environments.

2) The water vapor transmission rate is ≤800 g/m²·24 h, indicating a strong water vapor barrier property, which can reduce soil moisture loss.

3) Physical strength indices: tear index ≥2.5 mN·m²/g, burst index ≥2 kPa·m²/g, and wet tensile index ≥25% of the dry tensile index, ensuring that the mulching paper does not break or decompose during the covering period.

4) The light transmittance is ≤5%, which can effectively suppress the growth and development of weeds to achieve the purpose of weed growth suppression.

5) The relative biodegradation rate is ≥90%. After use, the mulching paper can be completely or mostly degraded into organic matter, which enters the soil and is conducive to improving the soil structure.

### BRIEF DESCRIPTION OF DRAWINGS

The accompanying drawings of the specification which form a part of the present invention are used for providing further understanding of the present invention. The illustrative examples of the present invention and the description thereof are used for explaining the present invention, and do not constitute improper limitation of the present invention.

FIG. 1 is a flowchart of preparation for a natural-color biodegradable mulching paper for a greenhouse.

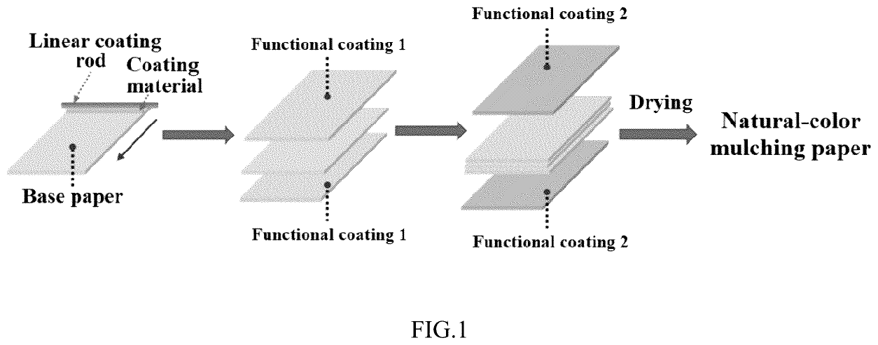

### DETAILED DESCRIPTION

It should be pointed out that the following detailed descriptions are all exemplary and are intended to provide further illustration of the present invention. Unless otherwise specified, all the technical and scientific terms used in the present invention have the same meanings as those commonly understood by those of ordinary skill in the art to which the present invention belongs.

The present invention is further illustrated in detail in conjunction with the following specific examples. It should be noted that these specific examples are intended to explain rather than limit the present invention.

### Example 1

Papermaking of a mulching base paper: taking approximately 500 g by bone dry mass of biomechanical pulp, beating the biomechanical pulp by using a Valley beater to obtain biomechanical pulps with beating degrees of about 20° SR, 30° SR, and 40° SR, separately; after the beating, filtering out most of moisture in the biomechanical pulps with a pulp bag, then placing the biomechanical pulps in a 5° C. low-temperature refrigerator for 24 h to balance the moisture, and then determining solid contents.

Taking and blending 1.88 g of bone dry pulp and a papermaking additive including 0.5% by bone dry pulp mass percentage of a CPAM as a dry strength agent, 2% by bone dry pulp mass percentage of a PAE as a wet strength agent, 0.5% by bone dry pulp mass percentage of an AKD as a sizing agent, and 0.10% by bone dry pulp mass percentage of a retention aid in a disintegrator, and performing a disintegration treatment at 10,000 rpm to completely disperse fibers, to obtain a pulp; after the disintegration treatment, feeding the pulp into a paper machine to obtain a mulching base paper with a basis weight of 60 g/m².

Coating experiment on the mulching base paper: first preparing a 5 wt % (percentage by weight) CAS aqueous solution, then adding a sodium hydroxide accounting for 10% of the starch mass, to obtain a mixture; mechanically stirring the mixture at 10,000 rpm for 30 min at 40° C. to obtain the gelatinized CAS; fixing the mulching base paper, and coating the gelatinized CAS uniformly on a front side of the mulching base paper with a 10-μm linear coating rod, followed by drying at 80° C. for 10 min in a drying apparatus, then taking out; then, coating the polyurethane above the gelatinized CAS coating coated on the front side with a 4-μm linear coating rod, followed by drying at 110° C. for 10 min to obtain the mulching paper.

The properties of mulching papers prepared with different beating degrees are shown in Table 1.

TABLE 1
Properties of mulching papers prepared with different beating degrees

| | | Water vapor | | | | | |
|---|---|---|---|---|---|---|---|
| | | transmission | | | Dry tensile | Wet tensile | Light |
| Beating | Cobb₁₂₀ | rate | Tear index | Burst index | index | index | transmittance |
| degree | g/m² | g/m² · 24 h | mN · m²/g | kPa · m²/g | N · m/g | N · m/g | % |
| 20°SR | / | / | 3.56 | 1.18 | 10.4 | 7.7 | 8.4 |
| 30°SR | / | / | 6.55 | 1.66 | 22.6 | 16.8 | 4.7 |
| 40°SR | / | / | 7.01 | 2.26 | 26.9 | 18.8 | 3.6 |

### Example 2

Papermaking of a mulching base paper: taking approximately 500 g by bone dry mass of biomechanical pulp, beating the biomechanical pulp using a Valley beater to obtain a treated biomechanical pulp with a beating degree of about 40° SR; after the beating, filtering out most of moisture in the treated biomechanical pulp with a pulp bag, then placing the filtered biomechanical pulp in a 5° C. low-temperature refrigerator for 24 h to balance the moisture, and then determining solid contents.

Taking and blending 1.88 g and 2.19 g of bone dry pulps and a papermaking additive including 0.5% by bone dry pulp mass percentage of a CPAM as a dry strength agent, 2% by bone dry pulp mass percentage of a PAE as a wet strength agent, 0.5% by bone dry pulp mass percentage of an AKD as a sizing agent, and 0.1% by bone dry pulp mass percentage of a retention aid in a disintegrator, respectively; and performing a disintegration treatment at 10,000 rpm to completely disperse the fibers to obtain pulps; after the disintegration treatment, feeding the pulps into a paper machine to obtain mulching base papers with basis weights of 60 g/m² and 70 g/m².

Coating experiment on the mulching base paper: first preparing a 5 wt % CAS aqueous solution, then adding a sodium hydroxide accounting for 10% of the starch mass, to obtain a mixture; mechanically stirring the mixture at 10,000 rpm for 30 min at 40° C. to obtain gelatinized CAS.

Fixing the mulching base paper, and coating the gelatinized CAS uniformly on a front side of the mulching base paper with a 10-μm linear coating rod, followed by drying at 80° C. for 10 min in a drying apparatus, then taking out; then, coating the polyurethane above the gelatinized CAS coating coated on the front side with a 4-μm linear coating rod, followed by drying at 110° C. for 10 min to obtain the mulching paper.

The properties of mulching papers prepared with different basis weights are shown in Table 2.

TABLE 2
Properties of mulching papers prepared with different papermaking basis weights

| Basis | | Water vapor | | | | | |
|---|---|---|---|---|---|---|---|
| weight of | | transmission | Tear | Burst | Dry tensile | Wet tensile | Light |
| base paper | Cobb₁₂₀ | rate | index | index | index | index | transmittance |
| g/m² | g/m² | g/m² · 24 h | mN · m²/g | kPa · m²/g | N · m/g | N · m/g | % |
| 60 | / | / | 7.01 | 2.26 | 26.9 | 18.8 | 3.6 |
| 70 | / | / | 7.23 | 2.34 | 28.1 | 19.5 | 3.4 |

### Example 3

Papermaking of a mulching base paper: taking approximately 500 g by bone dry mass of biomechanical pulp, beating the biomechanical pulp by using a Valley beater for about 20 min to achieve a beating degree of about 40° SR; after the beating, filtering out most of moisture in the biomechanical pulp with a pulp bag, then placing the biomechanical pulp in a 5° C. low-temperature refrigerator for 24 h to balance the moisture, and then determining solid contents.

Taking and blending 1.88 g of bone dry pulp and papermaking additives respectively including 0.5%, 1%, 1.5%, and 2% by bone dry pulp mass percentage of CPAM as dry strength agents, 2.5% by bone dry pulp mass percentage of a PAE as a wet strength agent, 0.5% by bone dry pulp mass percentage of an AKD as a sizing agent, and 0.10% by bone dry pulp mass percentage of a retention aid in a disintegrator, and performing a disintegration treatment at 10,000 rpm to completely disperse the fibers, to obtain a pulp; After the disintegration treatment, feeding the pulp into a paper machine to obtain a mulching base paper with a basis weight of 60 g/m².

Coating experiment on the mulching base paper: first preparing a 5 wt % CAS aqueous solution, then adding a sodium hydroxide accounting for 10% of the starch mass, to obtain a mixture; mechanically stirring the mixture at 10,000 rpm for 30 min at 40° C. to obtain the gelatinized CAS.

Fixing the mulching base paper, and coating the gelatinized CAS uniformly on both sides of the mulching base paper with a 10-μm linear coating rod, followed by drying at 80° C. for 10 min in a drying apparatus, then taking out; then, coating the polyurethane above the gelatinized CAS coatings coated on the both sides with a 4-μm linear coating rod, followed by drying at 110° C. for 10 min to obtain the mulching paper.

The properties of mulching papers prepared with different dry strength agent contents are shown in Table 3.

TABLE 3
Properties of mulching papers prepared with different dry strength agent contents

| Dry | | Water vapor | | | | | |
|---|---|---|---|---|---|---|---|
| strength | | transmission | | | Dry tensile | Wet tensile | Light |
| agent | Cobb₁₂₀ | rate | Tear index | Burst index | index | index | transmittance |
| content | g/m² | g/m² · 24 h | mN · m²/g | kPa · m²/g | N · m/g | N · m/g | % |
| 0.5% | 9.21 | 710 | 7.88 | 2.31 | 31.1 | 23.3 | 4.2% |
| 1% | 8.62 | 683 | 8.3 | 2.48 | 35.6 | 26.7 | 3.9% |
| 1.5% | 8.65 | 690 | 8.17 | 2.41 | 35.4 | 27.3 | 3.8% |
| 2% | 8.66 | 687 | 8.13 | 2.7 | 35.8 | 27.8 | 3.73% |

### Example 4

Papermaking of a mulching base paper: taking approximately 500 g by bone dry mass of biomechanical pulp, beating the biomechanical pulp by using a Valley beater for about 20 min to achieve a beating degree of about 40° SR; after the beating, filtering out most of moisture in the biomechanical pulp with a pulp bag, then placing the biomechanical pulp in a 5° C. low-temperature refrigerator for 24 h to balance the moisture, and then determining solid contents.

Taking and blending 1.88 g of bone dry pulp and papermaking additives including 1% by bone dry pulp mass percentage of a CPAM as a dry strength agent, 2%, 2.5% and 3% by bone dry pulp mass percentage of PAE respectively as wet strength agents, 0.5% by bone dry pulp mass percentage of an AKD as a sizing agent, and 0.1% by bone dry pulp mass percentage of a retention aid in a disintegrator, and performing a disintegration treatment at 10,000 rpm to completely disperse the fibers, to obtain pulps; after the disintegration treatment, feeding the pulps into a paper machine to obtain mulching base papers with a basis weight of 60 g/m².

Coating experiment on the mulching base paper: first preparing a 5 wt % CAS aqueous solution, then adding a sodium hydroxide accounting for 10% of the starch mass, to obtain a mixture; mechanically stirring the mixture at 10,000 rpm for 30 min at 40° C. to obtain gelatinized CAS.

Fixing the mulching base paper, and coating the gelatinized CAS uniformly on both sides of the mulching base paper with a 10-μm linear coating rod, followed by drying at 80° C. for 10 min in a drying apparatus, then taking out; then, coating the polyurethane above the gelatinized CAS coating coated on the both sides with a 4-μm linear coating rod, followed by drying at 110° C. for 10 min to obtain the mulching paper.

The properties of mulching papers prepared with different wet strength agent contents are shown in Table 4.

TABLE 4
Properties of mulching papers prepared with different wet strength agent contents

| Wet | | Water vapor | | | | | |
|---|---|---|---|---|---|---|---|
| strength | | transmission | | | Dry tensile | Wet tensile | Light |
| agent | Cobb₁₂₀ | rate | Tear index | Burst index | index | index | transmittance |
| content | g/m² | g/m² · 24 h | mN · m²/g | kPa · m²/g | N · m/g | N · m/g | % |
| 2% | 8.97 | 807 | 8.4 | 2.41 | 34.5 | 28.3 | 4.1 |
| 2.5% | 8.6 | 683 | 8.3 | 2.48 | 35.6 | 26.7 | 3.9 |
| 3% | 8.58 | 680 | 8.28 | 2.49 | 35.9 | 26.1 | 3.93 |

### Example 5

Papermaking of a mulching base paper: taking approximately 500 g by bone dry mass of biomechanical pulp, beating the biomechanical pulp by using a Valley beater for about 20 min to achieve a beating degree of about 40° SR; after the beating, filtering out most of moisture in the biomechanical pulp with a pulp bag, then placing the biomechanical pulp in a 5° C. low-temperature refrigerator for 24 h to balance the moisture, and then determining solid contents.

Taking and blending 1.88 g of bone dry pulp and a papermaking additive including 1% by bone dry pulp mass percentage of a CPAM as a dry strength agent, 2.5% by bone dry pulp mass percentage of a PAE as a wet strength agent, 0.5% by bone dry pulp mass percentage of an AKD as a sizing agent, and 0.1% by bone dry pulp mass percentage of a retention aid in a disintegrator, and performing a disintegration treatment at 10,000 rpm to completely disperse the fibers, to obtain a pulp; after the disintegration treatment, feeding the pulp into a paper machine to obtain a mulching base paper with a basis weight of 60 g/m².

Coating experiment on the mulching base paper: first respectively preparing 1 wt %, 5 wt % and 7 wt % CAS aqueous solutions, then adding a sodium hydroxide accounting for 10% of the starch mass, to obtain mixtures; mechanically stirring the mixtures at 10,000 rpm for 30 min at 40° C. to obtain gelatinized CAS.

Fixing the mulching base paper, and coating the gelatinized CAS uniformly on the front side of the mulching base paper with a 10-μm linear coating rod, followed by drying at 80° C. for 10 min in a drying apparatus, then taking out; then, coating acrylic resin above the gelatinized CAS coating coated on the front side with a 4-μm linear coating rod, followed by drying at 110° C. for 10 min to obtain the mulching paper.

The properties of mulching papers prepared with different CAS concentrations are shown in Table 5.

TABLE 5
Properties of mulching papers prepared with different CAS concentrations

| | | Acrylic | | | | | | | |
|---|---|---|---|---|---|---|---|---|---|
| | Starch | resin | | Water vapor | | | Dry | Wet | |
| | coating | coating | | transmission | Tear | Burst | tensile | tensile | Light |
| CAS | amount | amount | Cobb₁₂₀ | rate | index | index | index | index | transmittance |
| concentration | g/m² | g/m² | g/m² | g/m² · 24 h | mN · m²/g | kPa · m²/g | N · m/g | N · m/g | % |
| 1% | 0.7 | 5.26 | 7.9 | 668 | 7.5 | 2.14 | 25.1 | 19.23 | 4.1 |
| 5% | 1.27 | 3.2 | 8.4 | 749 | 7.01 | 2.26 | 25.7 | 18.8 | 3.6 |
| 7% | 1.89 | 1.7 | 8.6 | 683 | 7.3 | 2.48 | 28.7 | 19.23 | 3.5 |

It can be seen from Table 4 that the concentrations of gelatinized vary, resulting in differences in the actual coating amount of starch. When the concentration of gelatinized CAS increases, its pore-filling effect on fibers is improved, leading to a decrease in the coating amount of acrylic resin. This can also make the related properties of the mulching paper meet the requirements.

### Example 6

Papermaking of a mulching base paper: taking approximately 500 g by bone dry mass of biomechanical pulp, beating the biomechanical pulp by using a Valley beater for about 20 min to achieve a beating degree of about 40° SR; after the beating, filtering out most of moisture in the biomechanical pulp with a pulp bag, then placing the biomechanical pulp in a 5° C. low-temperature refrigerator for 24 h to balance the moisture, and then determining solid contents.

Taking and blending 1.88 g of bone dry pulp and a papermaking additive including 1% by bone dry pulp mass percentage of a CPAM as a dry strength agent, 2.5% by bone dry pulp mass percentage of a PAE as a wet strength agent, 0.5% by bone dry pulp mass percentage of an AKD as a sizing agent, and 0.1% by bone dry pulp mass percentage of a retention aid in a disintegrator, and performing a disintegration treatment at 10,000 rpm to completely disperse the fibers, to obtain a pulp; after the disintegration treatment, feeding the pulp into a paper machine to obtain a mulching base paper with a basis weight of 60 g/m².

Coating experiment on the mulching base paper: first preparing a 7 wt % CAS aqueous solution, then adding a sodium hydroxide accounting for 10% of the starch mass, to obtain a mixture; mechanically stirring the mixture at 10,000 rpm for 30 min at 40° C. to obtain gelatinized CAS. Fixing the mulching base paper, and coating the gelatinized CAS uniformly on both sides of the mulching base paper with a 10-μm linear coating rod, followed by drying at 80° C. for 10 min in a drying apparatus, then taking out; then, coating polycaprolactone (PCL), polyvinylidene chloride (PVDC), and modified starch above the gelatinized CAS coating coated on both sides with a 4-μm linear coating rod, followed by drying at 30° C. for 10 min to obtain the mulching paper.

The properties of mulching papers prepared with different hydrophobic and moisture-resistant coating materials are shown in Table 6.

TABLE 6
Properties of mulching papers prepared with different hydrophobic and moisture-resistant coating materials

| | | | Water vapor | | | Dry | Wet | |
|---|---|---|---|---|---|---|---|---|
| Hydrophobic and | Coating | | transmission | | | tensile | tensile | Light |
| moisture-resistant | amount | Cobb₁₂₀ | rate | Tear index | Burst index | index | index | transmittance |
| coating materials | g/m² | g/m² | g/m² · 24 h | mN · m²/g | kPa · m²/g | N · m/g | N · m/g | % |
| PCL | 22.7 | 7.9 | 140.8 | 8.1 | 2.83 | 45.7 | 36.6 | 5.1 |
| PVDC | 19.8 | 10.2 | 43.2 | 8.2 | 2.34 | 44.8 | 38.1 | 4.2 |
| Modified starch | 5.6 | 12.3 | 1389 | 7.9 | 2.26 | 41.6 | 24.9 | 4.4 |

During the experiment, the coating effects of PCL and PVDC were compared. Although they exhibit excellent hydrophobic and water vapor barrier properties, their coating processes are relatively difficult, and it is hard to reduce their coating amounts, resulting in high coating costs.

### Example 7

Papermaking of a mulching base paper: taking approximately 500 g by bone dry mass of biomechanical pulp, beating the biomechanical pulp by using a Valley beater for about 20 min to achieve a beating degree of about 40° SR; after the beating, filtering out most of moisture in the biomechanical pulp with a pulp bag, then placing the biomechanical pulp in a 5° C. low-temperature refrigerator for 24 h to balance the moisture, and then determining solid contents.

Taking and blending 1.88 g of bone dry pulp and a papermaking additive including 1% by bone dry pulp mass percentage of a CPAM as a dry strength agent, 2.5% by bone dry pulp mass percentage of a PAE as a wet strength agent, 0.5% by bone dry pulp mass percentage of an AKD as a sizing agent, and 0.1% by bone dry pulp mass percentage of a retention aid in a disintegrator, and performing a disintegration treatment at 10,000 rpm to completely disperse the fibers, to obtain a pulp; after the disintegration treatment, feeding the pulp into a paper machine to obtain a mulching base paper with a basis weight of 60 g/m².

Coating experiment on the mulching base paper: first preparing a 7 wt % CAS aqueous solution, then adding a sodium hydroxide accounting for 10% of the starch mass, to obtain a mixture; mechanically stirring the mixture at 10,000 rpm for 30 min at 40° C. to obtain gelatinized CAS. Fixing the mulching base paper, and coating the gelatinized CAS uniformly on both sides of the mulching base paper with a 10-μm linear coating rod, followed by drying at 80° C. for 10 min in a drying apparatus; then, coating the polyurethane above the gelatinized CAS coating coated on the both sides with a 4-μm linear coating rod, followed by drying at 110° C. for 10 min to obtain the mulching paper. The properties of the prepared mulching paper are shown in Table 7.

TABLE 7
Properties of the mulching paper

| | Water vapor | Tear | Burst | Dry tensile | Wet tensile | |
|---|---|---|---|---|---|---|
| Cobb₁₂₀ | transmission rate | index | index | index | index | Light |
| g/m² | g/m² · 24 h | mN · m²/g | kPa · m²/g | N · m/g | N · m/g | transmittance |
| 8.6 | 683 | 8.3 | 2.48 | 35.6 | 26.7 | 3.9% |

The mulching paper exhibits a Cobb₁₂₀ value of 8.6 g/m², demonstrating excellent water resistance that facilitates the sliding of water droplets on the surface and extends the service life of the mulching paper.

The water vapor transmission rate of the mulching paper is 683 g/m²·24 h, which is a 424% increase compared with the mulching base paper. Through the coating process, the mulching paper is endowed with a good water vapor barrier property, effectively preventing water loss from the soil and crops, and thus achieving the effect of increasing yield and improving efficiency.

The physical strength indices of the mulching paper are as follows: tear index of 8.3 mN·m²/g, burst index of 2.48 kPa·m²/g, dry tensile index of 35.6 N·m/g, and wet tensile index of 26.7 N·m/g. The results of the four tests all meet the requirements for laying in greenhouses. The wet tensile index reaches 75% of the dry tensile index, which is a 556% increase compared with the base paper. This indicates that the biomechanical pulp mulching paper can be used for an extended period even in high-humidity environments within greenhouses.

The mulching paper has a light transmittance of 3.9%, which can effectively suppress the growth and development of weeds. Therefore, in the area covered by the mulching paper, the purpose of suppressing weed growth is achieved.

### Example 8

Papermaking of a mulching base paper: taking approximately 500 g by bone dry mass of biomechanical pulp, beating the biomechanical pulp by using a Valley beater for about 20 min to achieve a beating degree of about 40° SR; after the beating, filtering out most of moisture in the biomechanical pulp with a pulp bag, then placing the biomechanical pulp in a 5° C. low-temperature refrigerator for 24 h to balance the moisture, and then determining solid contents.

Taking and blending 1.88 g of bone dry pulp and a papermaking additive including 1% by bone dry pulp mass percentage of a CPAM as a dry strength agent, 2.5% by bone dry pulp mass percentage of a PAE as a wet strength agent, 0.5% by bone dry pulp mass percentage of an AKD as a sizing agent, and 0.1% by bone dry pulp mass percentage of a retention aid in a disintegrator, and performing a disintegration treatment at 10,000 rpm to completely disperse the fibers, to obtain a pulp; after the disintegration treatment, feeding the pulp into a paper machine to obtain a mulching base paper with a basis weight of 60 g/m².

Coating experiment on the mulching base paper: first preparing a 7 wt % CAS aqueous solution, then adding a sodium hydroxide accounting for 10% of the starch mass, to obtain a mixture; mechanically stirring the mixture at 10,000 rpm for 30 min at 40° C. to obtain gelatinized CAS.

Fixing the mulching base paper, and coating the gelatinized CAS uniformly on both sides of the mulching base paper with a 10-μm linear coating rod, followed by drying at 80° C. for 10 min in a dry apparatus, then taking out.

After the taking out, coating acrylic resin above the gelatinized CAS coating coated on the both sides with a 4-μm linear coating rod, followed by drying at 110° C. for 10 min to obtain the mulching paper.

The properties of the prepared mulching paper are shown in Table 8.

TABLE 8
Properties of the mulching paper

| | Water vapor | | | | | |
|---|---|---|---|---|---|---|
| | transmission | | | Dry tensile | Wet tensile | |
| Cobb₁₂₀ | rate | Tear index | Burst index | index | index | Light |
| g/m² | g/m² · 24 h | mN · m²/g | kPa · m²/g | N · m/g | N · m/g | transmittance |
| 18.7 | 734 | 7.3 | 2.27 | 44.7 | 20.7 | 4.5% |

The water resistance of the mulching paper Cobb₁₂₀ is 18.7 g/m², showing a certain hydrophobic property, which helps to extend the service life of the mulching paper in humid environments.

The water vapor transmission rate of the mulching paper is 734 g/m²·24 h, which is a 394% increase compared to the mulching base paper. By coating acrylic resin, the water vapor barrier property of the mulching paper remains below 800 g/m²·24 h, and the cost is lower than that of polyurethane.

The physical strength indices of the mulching paper are as follows: tear index of 7.3 mN·m²/g, burst index of 2.27 kPa·m²/g, dry tensile index of 44.7 N·m/g, and wet tensile index of 20.7 N·m/g. The results of the four tests all meet the requirements for laying in greenhouses. The wet tensile index reaches 46% of the dry tensile index, which is a 431% increase compared with the base paper. Compared with Example 1, Example 2 demonstrates a higher dry tensile index.

The mulching paper has a light transmittance of 4.5%, which can still effectively suppress the growth and development of weeds to achieve the purpose of suppressing weed growth.

### Comparative Example 1

Papermaking of a mulching base paper: taking approximately 500 g by bone dry mass of biomechanical pulp, beating the biomechanical pulp by using a Valley beater for about 20 min to achieve a beating degree of about 40° SR; after the beating, filtering out most of moisture in the biomechanical pulp with a pulp bag, then placing the biomechanical pulp in a 5° C. low-temperature refrigerator for 24 h to balance the moisture, and then determining solid contents.

Taking and blending 1.88 g of bone dry pulp and a papermaking additive including 1% by bone dry pulp mass percentage of a CPAM as a dry strength agent, 2.5% by bone dry pulp mass percentage of a PAE as a wet strength agent, 0.5% by bone dry pulp mass percentage of an AKD as a sizing agent, and 0.1% of a retention aid in a disintegrator, and performing a disintegration treatment at 10,000 rpm to completely disperse the fibers, to obtain a pulp; after the disintegration treatment, feeding the pulp into a paper machine to obtain a mulching base paper with a basis weight of 60 g/m².

Coating experiment on the mulching base paper: first preparing a 7 wt % CAS aqueous solution, then adding a sodium hydroxide accounting for 10% of the starch mass, to obtain a mixture; mechanically stirring the mixture at 10,000 rpm for 30 min at 40° C. to obtain gelatinized CAS. Fixing the mulching base paper, and coating the gelatinized CAS uniformly on both sides of the mulching base paper with a 10-μm linear coating rod, followed by drying at 80° C. for 10 min in a drying apparatus, then taking out.

The properties of the prepared mulching paper are shown in Table 9.

TABLE 9
Properties of the mulching paper

| | Water vapor | | | Dry tensile | Wet tensile | |
|---|---|---|---|---|---|---|
| Cobb₁₂₀ | transmission rate | Tear index | Burst index | index | index | Light |
| g/m² | g/m² · 24 h | mN · m²/g | kPa · m²/g | N · m/g | N · m/g | transmittance |
| 24.7 | 2076 | 7.6 | 2.3 | 38.4 | 10.7 | 4.2% |

The above are only the preferred examples of the present invention and are not intended to limit the present invention. For those skilled in the art, the present invention can have various modifications and variations. Any modifications, equivalent substitutions, improvements, etc. made within the spirit and principles of the present invention shall be included within the scope of protection of the present invention.

1. A method for preparing a mulching paper for a greenhouse, comprising the following steps:
disintegrating a biomechanical pulp of wheat straw, and then subjecting the biomechanical pulp to beating treatment with a beating degree of 35° SR-40° SR to obtain a pulp slurry;
thoroughly mixing the pulp slurry with a papermaking additive, and then performing papermaking to obtain a mulching base paper;
uniformly coating one side or both sides of the mulching base paper with gelatinized cationic starch (CAS) or gelatinized soybean oil-modified starch, and drying; wherein a mass percentage of a CAS aqueous solution during gelatinization is 3%-10%; and a mass percentage of starch in the soybean oil-modified starch is 2.5%-10%; and
then uniformly coating the one side or the both sides with a polyurethane coating or an acrylic resin coating, and drying to obtain the mulching paper.

2. The method for preparing the mulching paper for the greenhouse according to claim 1, further comprising a step of adding 0-40% by mass percentage of waste corrugated paper pulp or 0-40% by mass percentage of wheat straw pulp to the biomechanical pulp of wheat straw, wherein an addition ratio of the waste corrugated paper pulp or the wheat straw pulp is not 0.

3. The method for preparing the mulching paper for the greenhouse according to claim 1, wherein the papermaking additive comprises 0.5%-3% by a bone dry pulp mass percentage of cationic polyacrylamide (CPAM) or CAS or chitosan, 1.5%-3% by the bone dry pulp mass percentage of polyamide polyamine epichlorohydrin (PAE), 0.5%-2% by the bone dry pulp mass percentage of alkyl ketene dimer (AKD) or aluminum sulfate, and 0.1%-0.3% by the bone dry pulp mass percentage of cationic/anionic polyacrylamide or cationic/anionic starch.

4. The method for preparing the mulching paper for the greenhouse according to claim 1, wherein a method for preparing the gelatinized CAS comprises: adjusting the GAS aqueous solution to an alkaline condition, then heating the GAS aqueous solution to 40° C.-50° C., and stirring for 20-40 min to obtain the gelatinized GAS;
wherein, the mass percentage of the GAS aqueous solution is 3%-10%; and
in the GAS aqueous solution, a mass percentage of sodium hydroxide is 8%-15%.

5. The method for preparing the mulching paper for the greenhouse according to claim 1, wherein a method for preparing the soybean oil-modified starch comprises: adding soybean oil and sodium carbonate to a dimethyl sulfoxide solution of the starch to obtain a mixed solution, and heating the mixed solution to 110° C.-150° C. for 1-3 h, and then carrying out a hydrophobic modification on the starch to the modified starch;
wherein, in the mixed solution, the mass percentage of the starch is 2.5%-10%; a mass percentage of the soybean oil is 8%-12%; and a mass percentage of the sodium carbonate is 13%-17%.

6. The method for preparing the mulching paper for the greenhouse according to claim 1, wherein a method for coating the gelatinized GAS or the gelatinized soybean oil-modified starch comprises: using a 10-μm linear coating rod to coat a surface of the mulching base paper, and drying;
wherein, a single-side coating amount of the gelatinized CAS coating or the gelatinized soybean oil-modified starch coating is 1.5-2 g/m², and a double-side coating amount of the gelatinized CAS coatings or the gelatinized soybean oil-modified starch coatings is 3-4 g/m².

7. The method for preparing the mulching paper for the greenhouse according to claim 1, wherein a method for coating the polyurethane or acrylic resin coating is: using a 4-am linear coating rod to coat a surface of a gelatinized CAS coating or a gelatinized modified starch coating, and drying.

8. The method for preparing the mulching paper for the greenhouse according to claim 1, wherein a single-side coating amount of polyurethane is 1.5-2 g/m², and a double-side coating amount of polyurethane is 3-4 g/m²;
wherein, a single-side coating amount of acrylic resin is 2.5-3 g/m², and a double-side coating amount of acrylic resin is 5-6 g/m².

9. The method for preparing the mulching paper for the greenhouse according to claim 1, wherein a basis weight of the mulching base paper is 60-70 g/m².

10. A mulching paper for a greenhouse, prepared by the preparation method according to claim 1.
